(19) United States
(12) Patent Application Publication
(10) Pub. No.: US 2012/0124127 A1
(43) Pub. Date: May 17, 2012

(54) TCP/IP ON-TIME SYSTEM

(76) Inventor: Michael McGrady, Tacoma, WA (US)

(21) Appl. No.: 13/103,837

(22) Filed: May 9, 2011

Related U.S. Application Data
(60) Provisional application No. 61/332,306, filed on May 7, 2010.

(51) Int. Cl. G06F 15/16

(52) U.S. Cl. 709/203

(57) ABSTRACT

An in-memory tuple-space is created for a primary data store or access by information content versus content location. A very-small-imprint hypervisor or other implementation of a MILS architecture is created underneath the space or other store and used for store and transport of messages and/or information. This provides scalability, performance and solves the problem of delays in development authorization in multilevel security applications.

### CROSS-REFERENCE TO RELATED APPLICATIONS

This application claims priority to U.S. Provisional Appl. No. 61/332,306 entitled “TCP/IP ON-TIME SYSTEM” filed May 7, 2010, which is hereby incorporated by reference in its entirety.

### BACKGROUND OF THE INVENTION

A distributed computing system consists of multiple autonomous computers that communicate through a computer network. The computers interact with each other in order to achieve a common goal. To facilitate messaging functionality, some such systems employ front-end caches for data bases. However, this approach does not resolve problems associated with the CAP Theorem (Brewer's Theorem), lack of scalability or multilevel security.

Other problems with the prior art not described above can also be overcome using the teachings of embodiments of the present invention, as would be readily apparent to one of ordinary skill in the art after reading this disclosure.

### BRIEF DESCRIPTION OF THE DRAWING

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is an exemplary schematic illustration of modules/services according to an embodiment of the invention;

FIG. 4 illustrates real-time quality of service performance according to an embodiment of the invention;

FIG. 5 illustrates messaging architectures that may be utilized according to an embodiment of the invention;

FIG. 6 illustrates JMS messaging according to an embodiment of the invention;

FIG. 7 illustrates DDS messaging according to an embodiment of the invention;

FIG. 8 illustrates Spaces/GigaSpaces according to an embodiment of the invention;

FIG. 9 illustrates a MILS architecture according to an embodiment of the invention; and

FIG. 10 is a functional block diagram illustrating components of an embodiment of the invention.

### DETAILED DESCRIPTION OF THE PREFERRED EMBODIMENT

Embodiments of the invention are operational with general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

An embodiment of the invention leverages remote programming concepts by utilizing processes called mobile agents (sometimes referred to as mobile objects or agent objects). Generally speaking, these concepts provide the ability for an object (the mobile agent object) existing on a first (“host”) computer system to transplant itself to a second (“remote host”) computer system while preserving its current execution state. The operation of a mobile agent object is described briefly below.

The instructions of the mobile agent object, its preserved execution state, and other objects owned by the mobile agent object are packaged, or “encoded,” to generate a string of data that is configured so that the string of data can be transported by all standard means of communication over a computer network. Once transported to the remote host, the string of data is decoded to generate a computer process, still called the mobile agent object, within the remote host system. The decoded mobile agent object includes those objects encoded as described above and remains in its preserved execution state. The remote host computer system resumes execution of the mobile agent object which is now operating in the remote host environment.

While now operating in the new environment, the instructions of the mobile agent object are executed by the remote host to perform operations of any complexity, including defining, creating, and manipulating data objects and interacting with other remote host computer objects.

File transfer and/or synchronization, according to an embodiment, may be accomplished using some or all of the concepts described in commonly owned U.S. patent application Ser. No. 11/739,083, entitled “Electronic File Sharing,” the entirety of which is incorporated by reference as if fully set forth herein.

An embodiment of the invention provides a tuple-spaces information store combined with a MILS architecture for multilevel security. An embodiment of the invention provides a high-performance, high-integrity, scalable, multilevel security in-memory information fabric (cloud) that is transparent to the application level and resolves some problems of the CAP Theorem (Brewer's Theorem) and operates in a multilevel security environment.

In an embodiment, an in-memory tuple-space is created for a primary data store or access by information content versus content location. A very-small-imprint hypervisor or other implementation of a MILS architecture is created underneath the space or other store and used for store and transport of messages and/or information. This provides scalability, performance and solves the problem of delays in development authorization in multilevel security applications.

An embodiment of the invention provides Java spaces combined with a MILS architecture for virtual machines using a small footprint hypervisor.

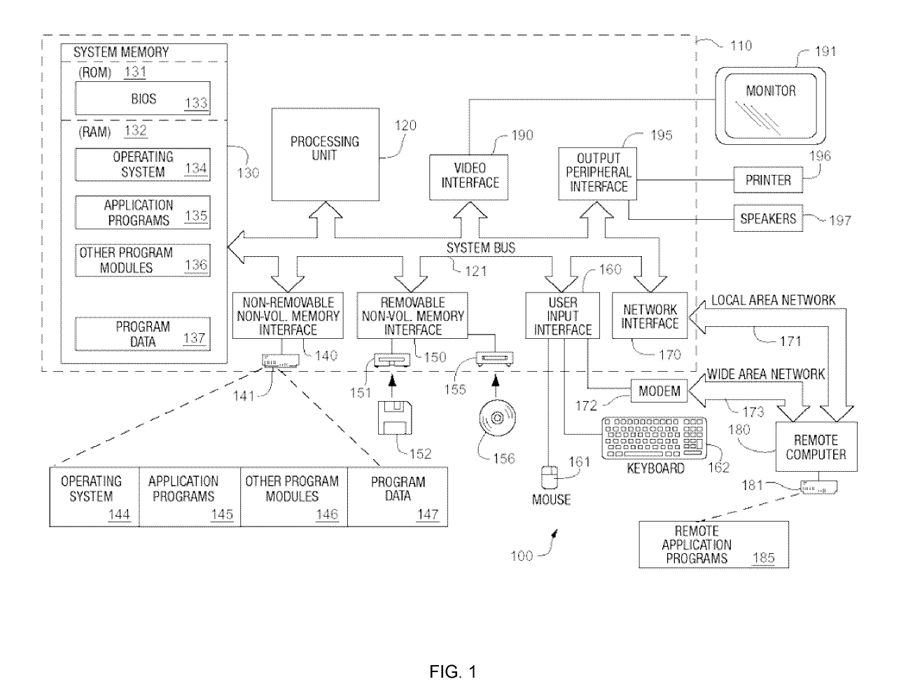

FIG. 1 illustrates an example of a suitable computing system environment 100 in which one or more embodiments of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

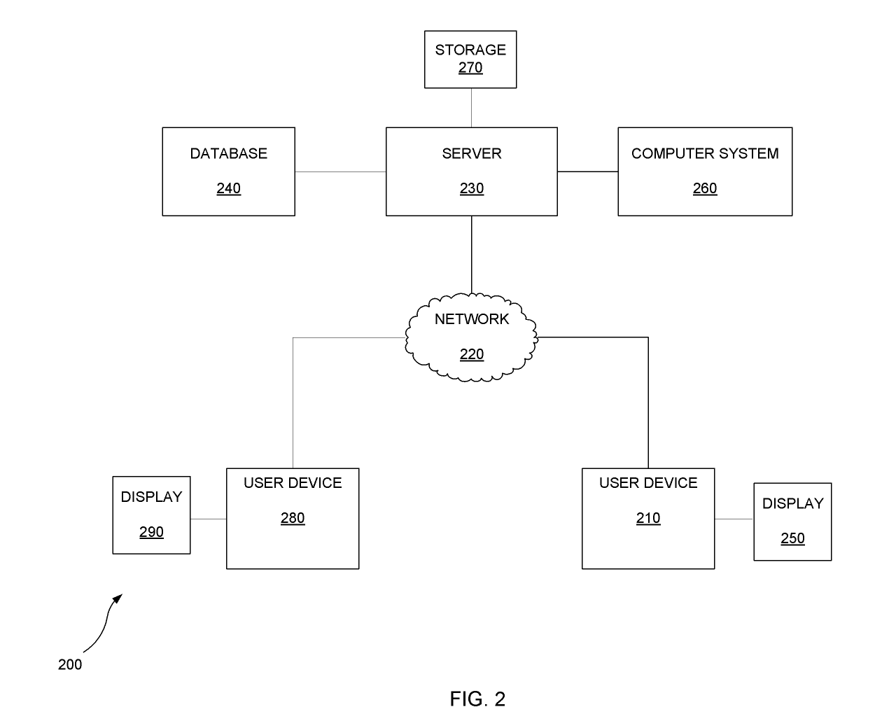

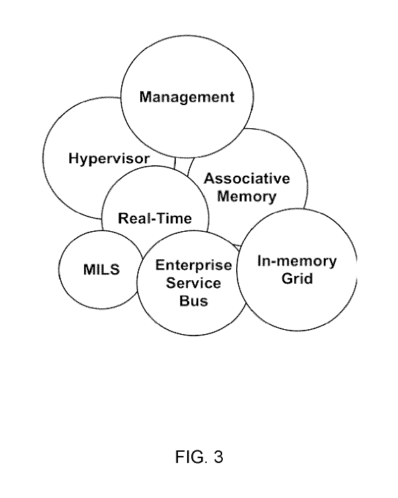

Referring now to FIG. 2, an embodiment of the present invention can be described in the context of an exemplary computer network system 200 as illustrated. System 200 includes electronic user devices 210, 280, such as personal computers, servers or workstations, that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the computer 110 illustrated in and discussed with reference to FIG. 1. User devices 210, 280 may include or be otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on one or more of the user devices 210, 280 can cooperate in two-way communication with server 230 and one or more applications running on server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

The Kolona Gateway is a modular, cross-domain and multilevel security gateway capable of connecting the Global Information Grid (GIG) in a pluggable manner to civilian air traffic management authorities worldwide in a NextGen context. An embodiment of the invention, which may be otherwise be referred to herein as the Kolona On-Time System, includes a multipurpose container built to NextGen specifications as a framework for the Gateway application. The Kolona On-Time System is:

1. Capable of more than eight million full-blown transactions a minute.

2. Capable of near linear scalability.

3. Real-time (RT) enabled.

4. Cross-domain (CD) enabled.

5. Multilevel Security (MLS)—based on Multiple Independent Levels of Security (MILS)—enabled.

6. With very high assurance.

7. With very high integrity.

This paper presents an overview of the system architecture for the Kolona On-Time System. The Kolona On-Time System was carefully engineered for NextGen compatibility and non-functional, quality control criteria (QCC), e.g., interoperability, scalability, etc. (the “ilities”).

1. The Initial Challenge

The Electronic Systems Command (ESC) of the Air Force provides the latest in command and control and information systems for the Air Force, the Department of Defense (DoD), and our allies. ESC currently manages approximately 200 programs with an annual budget of more than $3 billion and includes the 350th Electronic Systems Wing, 551st Electronic Systems Wing, 554th Electronic Systems Wing, 653rd Electronic Systems Wing, ESC Acquisition Center of Excellence, ESC Functional and Command Staff Offices, and Computer Accommodations Program. In addition, Hanscom supports the Air Force Research Laboratories (AFRL), Sensors and Space Vehicles directories, MIT Lincoln Laboratory, the MITRE Corporation and various other companies and groups related to DoD.

For the envisioned SBIR, NextGen requirements were involved. ESC assumed a volume of traffic that was three times the present day traffic, which, due to the resultant aircraft proximity, drove the performance requirements. Time constraints from radar to Air Traffic Control (ATC) were identified as 2.3 seconds with further requirements of 1.5 seconds on approach and 1.0 second on the runway, assuming a transmission time of 0.3 seconds.

The gateway cluster or container, further, had to be cross-domain, multilevel security, i.e., secret and below (SABI), and capable of very high integrity. Optionally advantageously, the gateway had to provide for quality of service (QoS) guarantees, which by the nature of the involved systems could not be end-to-end.

2. Meeting the Challenge: A Review of Architecture First Principles

A quick architectural survey of the foundations of the Kolona On-Time System is in order, so that the reader gets a feel for which sides of architectural divides we chose in crafting the system. The Kolona On-Time System is modular, so modules represent such choices. This survey is followed in Section 3 by a more in depth look at some of the modules, examples of which are represented in FIG. 2.

In this section we will provide a number of subsections briefly reviewing the reasons for the Kolona On-Time System architectural choices.

2.1. Deadlines: Speed Not a Sufficient Condition

Speed is not what the ESC of the Air Force wanted. Assurance is what was wanted. Assurance that information would be on time, warranting a guarantee that aircraft would be adequately informed to be protected against collisions.

The speed of execution perhaps surprisingly, then, may not, but could, be a prime value in a high performance, mission critical context. Assurance of performance in a particular case is advantageous. Is the deadline for information in this case met? System execution can be given time constraints, deadlines. These are called “real-time” constraints and it is a part of real-time programming, real-time operating systems (RTOS), and real-time languages. This is not the sense of the term that is used when generally we talk about “real-time” features in information technology (IT). Normally we say “real-time” when we talk about live data, the present, taking care of business on the fly, and so on. But in this paper we mean “true” real-time, a specific assurance that real-time constraints will be met in the operation of a system.

The fundamental requirement is that information be on time, that requirement deadlines be met 100 percent of the time, not 99.99 percent of the time. If deadlines were met 99.99 percent of the time with time to spare, the 0.01 percent exception is unacceptable. Hence, Topia Technology's system is called the “Kolona On-Time System”. This “on-time” is assurance that deadlines will be met.

Enterprise engineers not familiar with “real-time” (embedded) programming will, perhaps, say that 100 percent guarantees cannot be provided. But they can. Real-time embedded system engineers are more than familiar with these guarantees. Kolona On-Time System will bring these guarantees for the first time to enterprise systems.

The first decision in the Kolona On-Time System, then, was that RTOS, real-time language, real-time programming, and so on may be involved. This is optionally advantageous because there is a penalty for real-time programming. The execution of real-time systems has to maintain strict clocking functions connected all the way to the operating system and this is expensive in CPU cycle use.

This is the On-Time Module (Service).

2.2. Performance: Speed a Necessary Condition

Speed is a necessary condition, even though it is not a sufficient condition. A guarantee of on-time delivery necessitated speed in the operation of the Kolona On-Time System. How to get raw speed out of the box may be optionally advantageous to even a chance that the Kolona On-Time System would be adequate to meet deadlines. There is no guarantee that real-time systems will succeed. Sometimes we have to say that they cannot work given our choices. The Kolona On-Time System needed raw speed that would be unusual for enterprise systems.

From 1986 to 2000, CPU speed improved at an annual rate of 55% while memory speed only improved at 10%. The advantages in the growth of CPU speed can be quickly lost whenever memory speed becomes a part of the equation. This is called the “memory wall”. Escaping the memory wall is optionally advantageous to achieving the speed the Kolona On-Time System may need. Happily, in-memory operations, i.e., Random Access Memory (RAM), were increasing in size so that an in-memory data grid for an enterprise system was feasible. A 64-bit architecture is optionally advantageous for this in-memory grid. And these have become available too.

Topia Technology's architectural choice at the outset, in an embodiment, was that domain level functionality be executed within the boundaries of an in-memory data grid, with system bus or caching CPU speed, which is 10,000 times faster than disk speed and is virtually instantaneous. If the architecture could be adhered to at every level, the Kolona On-Time System would be blazing fast and more than enough to offset RTOS execution penalties. This is the In-Memory Grid Module (Service).

2.3. SOA and ESB

A Service Oriented Architecture (SOA) virtually precludes anything other than a federated enterprise architecture and, so, requires an Enterprise Service Bus (ESB), which is used to decouple integration logic in a distributed environment. So an ESB can be fairly assumed in the SBIR context. However, a Staged Event-Driven Architecture (SEDA) is less apparent than an ESB requirement.

Enterprise systems are built for huge load demands. SEDA is an architecture used to take care of load spikes in peak demand, the so-called “Slashdot Effect,” for highly concurrent systems with load spikes. Highly concurrent systems with load peaks have tried threading and event interfaces. SEDA combines the two. SEDA decomposes services into stages separated by queues, where each stage performs a subset of request processing and the stages internally are event-driven using nonblocking queues. Each stage contains a thread pool driving stage execution. Threads are not exposed to applications. Thus SEDA provides the programmability of threads with the explicit flow of events, using the best of both threads and events.

This is the ESB Module (Service).

2.4. Scaling, Distributed Associative Memory Paradigm, and Spaces

Scaling is the ability of a network to function as use increases. Suppose a machine can handle 500 requests per second. An architecture that perfectly scales, then, may handle 1,000 requests with two machines, 1,500 with three machines, and so on. But this is not the norm. Without a special architecture, scaling is poor. The second machine might only increase the load a machine can handle by 100 requests per second, for a total of 600 requests per second. Likewise, multiple additions of machines typically degrade the level of scaling.

The Kolona On-Time System had to scale at near-perfect, near-linear, levels. The Kolona On-Time System adapts a distributed associative memory paradigm. An associative memory paradigm is where information is located by content, not location, thus radically simplifying the handling of information at a number of surprising and deep levels. A tuple space technology, JavaSpaces and GigaSpaces, was adapted for this distributed associative memory paradigm.

The associative memory technology solves a number of fairly intractable problems: first, nearly linear scalability is guaranteed; second, anonymous objects are involved keeping bookkeeping to a minimum; third, data can be accompanied by optionally advantageous functionality, obviating the need for remote information massaging; fourth, the normalization issues in the Structure Query Language (SQL) are avoided, since objects were identified by content and are not capable of being duplicated, since tuple spaces are set-theoretic; and, fifth, multicast queries can be made for system wide inquiries without creating an issue of scale.

This is the Space Module (Service).

2.5. Security

There are a number of security modules (services). However, prior to briefly discussing the security modules, we will look at the architectural choices of the Kolona On-Time System providing the basis for the security modules.

John Rushby, RTI International, developed a Multiple Levels of Security (MILS) architecture that both created compositional security architecture and protected against covert channels endemic to other security architectures. He called the architecture the Multiple Independent Levels of Security (MILS) architecture. Optionally advantageously, the MILS architecture creates a decoupling of security policy and the provision of machine resources, i.e., a separation kernel (SK). The requirement that the Kolona On-Time System be both certified and accredited for multiple civilian air traffic management (ATM) authorities on a pluggable basis made the MILS compositional architecture optionally advantageous. Otherwise, the expense of certification and accreditation for each change in worldwide ATM authorities would be financially dire.

The Kolona On-Time System uses a further module (service) to enforce the separation kernel.

3. Modules/Services Expanded

3.1. Real-Time

There are two senses of “real-time” in the industry and they are not the same. The first and most prevalent sense is operating in the present tense; something happening now: something that is time sensitive. The idea in this first sense is that if processes are slow, then we have to wait. The second sense is a functional constraint involving time in processing algorithms and intimately related to the temporal predictability of the processes or guarantees that things will be performed according to a time schedule.

The idea in this sense is that the speed of processes is irrelevant and deadlines are all important. Real-time is insuring that deadlines are met according to schedule. There are connected ideas or senses to this last meaning of “real-time”. For example, we can order processes not so much to meet deadlines but to maximize a system's utility in meeting deadlines: Jensen Utility Functions are optionally advantageous in this connected idea or sense involving guarantees, not of meeting deadlines but in achieving the highest utility given certain deadlines.

Time constraints are subject to the clock. Speed may be sacrificed for predictability. Java RTS performance, then, is measured two ways: throughput performance for non-real-time logic and predictability performance for hard real-time logic, which is measured in the maximum latency and jitter. For non-real-time Java, Java RTS is, conservatively, up to 85% as fast. For real-time Java, the reference platform (which is relatively slow) has a maximum latency of 20 microseconds and a maximum jitter of 10 microseconds.

The real-time involved in the On-Time System, as the name indicates, is a guarantee that the system will meet deadlines. Deadlines are sacrosanct in the On-Time Module (Service) of the On-Time System. Deadlines are a part of the algorithm and, exactly like 2+6=8 must be the successful result of the algorithm 100% of the time, so meeting deadlines must occur 100% and not 99.999999% of the time or any other approximation. Thus, deadlines are all hard deadlines in the On-Time System and, so, a limiting case of the soft deadlines in real-time systems (Jensen). Deadlines, however, have a window in the On-Time System. That is, deadlines have a point where they are met (not too early) and a point where they are not met (not too late) and these times are not the same.

3.1.1. ATC and ATM Information Priority One

None of the air traffic control (ATC) and management (ATM) information can be jettisoned or meet its useful deadlines. So, the issue is not whether the information takes precedence it is what the deadlines are. We assumed in the Kolona On-Time System that all information must meet its deadlines. The issue, then, became doing that with the least safe resources, e.g., bandwidth, used.

3.1.1. The Real-Time Specification for Java (RTSJ)

With the optional goal not to change the Java language syntax, RTSJ provides for:

1. Thread scheduling (28 unique priorities can be made available).

2. Memory management is separate from garbage collection (GC), defining new memory areas and specifying that GC should not interfere with these areas.

3. Priority inversion control is managed through a priority inheritance protocol.

4. Asynchronous events are executed with scheduling and dispatch handled by a real-time scheduler.

5. The Java exception handler mechanism is extended to shift from execution in one location to another in a real-time thread.

6. The RTSJ specifies a safe means of thread termination.

7. Physical memory access is allowed for byte-level access and object creation in order to handle latency issues.

The Java RTS 2.2 is based on a multicore 64-bit OS architecture.

3.1.2. Real-Time for the On-Time System

The Real-Time Module for the On-Time System is a module in progress, which we intend to extend at the Real-Time Module level for reuse for each successive application. For the GIG/SWIM gateway we provide an application level QoS solution that substitutes for the difficulty that cross-domain gateways are not likely to be end-to-end or not likely to share underlying resources such that a de facto end-to-end set of algorithms for QoS may be available.

This is a relatively simple but optionally advantageous real-time architecture. The basic idea is that all deadlines must be met and optionally advantageously function as hard real-time deadlines. Thus, the idea is to save bandwidth, not sacrifice data of lesser importance. Data passed between the GIG and the, for example, National Airspace System (NAS) is, we believe, never unimportant data. The basic issue in this case is that over-provisioning be avoided. The On-Time Module, then, is dedicated to providing a predictable maximum bandwidth less than the optionally advantageous bandwidth without the On-Time Module.

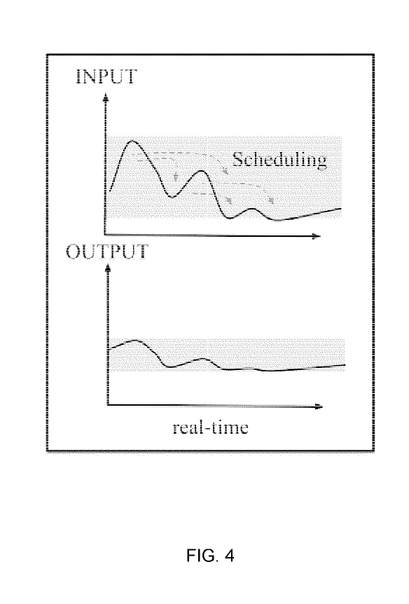

Referring to FIG. 4, consider that the optionally advantageous bandwidth without the On-Time Module is one measure, then the On-Time Module's is to generate an algorithm to move data in peaks to data in later valleys such that the predictable maximum bandwidth is less than the optionally advantageous bandwidth without the On-Time Module.

3.2. Spaces

3.2.1. Messaging

Transport is a fundamental architecture within an enterprise system. Typically SOA architectures employ event-based messaging transports. There is a certain complexity negatively involving the scalability of systems inherent in a messaging architecture. The messaging architecture wraps data in a message and the data is dumb to the architecture of the system. This causes certain complexities, due to the fact that data needs to be externally monitored, that affect scalability.

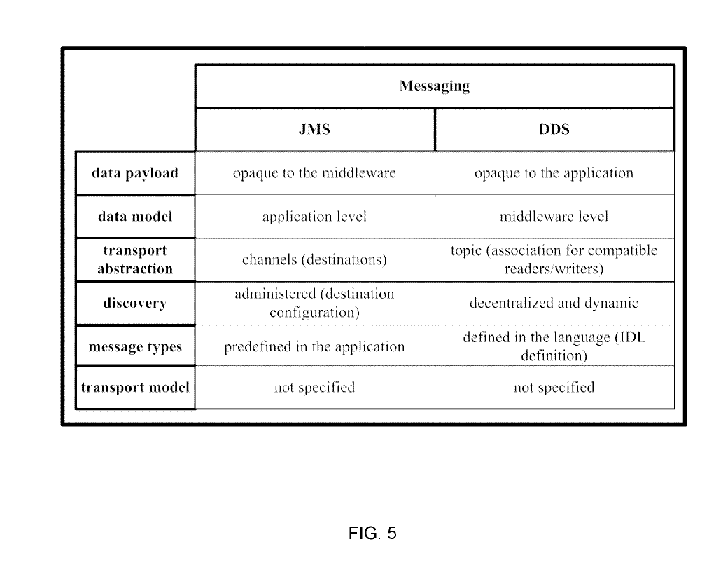

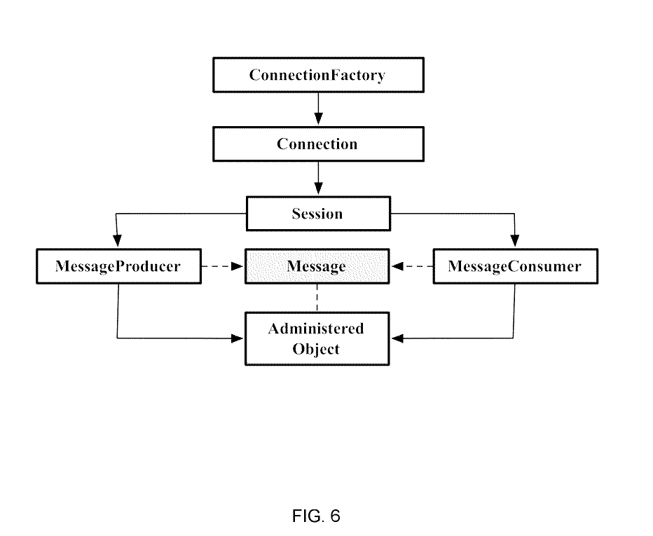

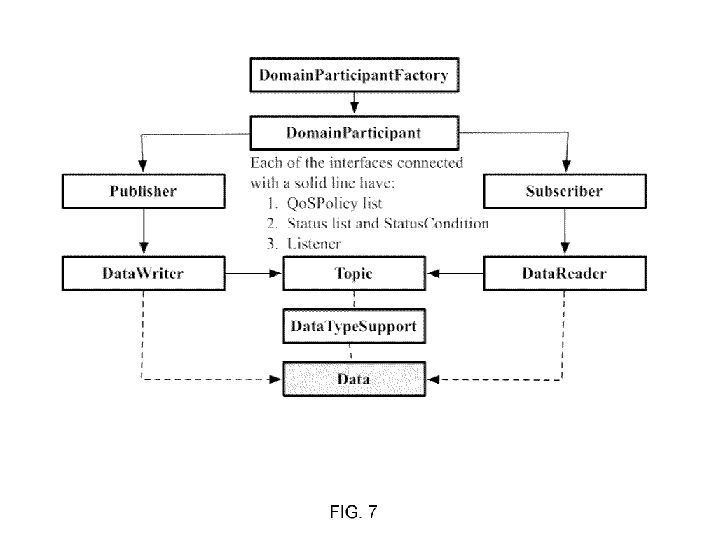

Referring to FIGS. 5, 6 and 7, two modern and current messaging architectures are Java Messaging Service (JMS) and Data Distribution Service (DDS). In JMS the data payload is opaque to the middleware. In DDS the data is interpreted by the middleware.

The data model is at the application level in JMS client software.

JMS works with channels. Channels represent destinations. A destination acts as a mini-broker. JMS discovery is administered. Destinations can be configured before clients can use them. JMS predefines message types. JMS does not specify a transport model. JMS does provide warrants with its delivery that matched TCP reliability.

DDS is data-centric in the sense that it supports a relational data model common to databases and manages the data at the middleware level.

A DDS topic is an association between compatible readers and writers that are bound to the same topic. Each topic has a name, type and associated QoS. Readers and writers are asynchronous endpoints. DDS discovery is decentralized and dynamic. DDS uses data types defined in the programming language, commonly defined by an Interface Definition Language (IDL). DDS does not specify a transport. DDS does not depend upon a reliable delivery.

DDS is similar to a shared database integration model. Integration models include file transfer, shared database, remote procedure invocation and messaging. DDS is in essence a backward step in time with all the benefits of modern tools and methods. The difference is that the topic with DDS need not be the singular database equivalent. Any node on the network can be a publisher or subscriber of many different topics.

3.2.2. Spaces: GigaSpaces XAP

The albatross in messaging is the notion of location. Location is inherent in messaging. The data has a location. Location enabled data can be duplicated and as such is subject to all the complexities that entails. There is an option, a distributed associative memory paradigm (AMP). Data in an AMP is accessed by content, not by location. Tuple spaces are a distributed AMP. GigaSpaces is a happy combination of a visionary and pragmatic company. GigaSpaces forked JINI, now Apache River, and has gone on to built a cloud friendly architecture that makes sense. The idea of a space for data, retrieving the data based on content, automatically brings simplicity to systems, “solving” or making impossible many and perhaps most challenges before they arise. The authors closely follow the specifications and value proposition for GigaSpaces articulated in a white paper on the product, allowing GigaSpaces to speak for itself, while paraphrasing.

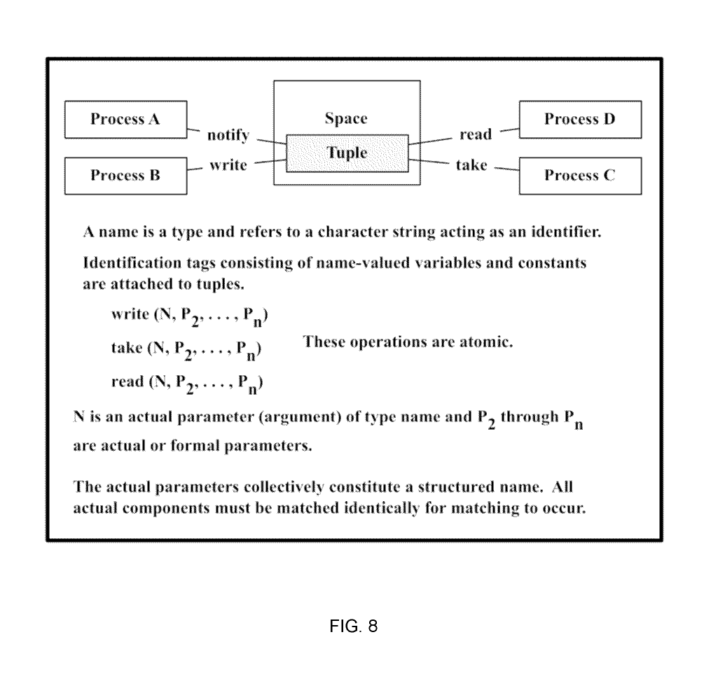

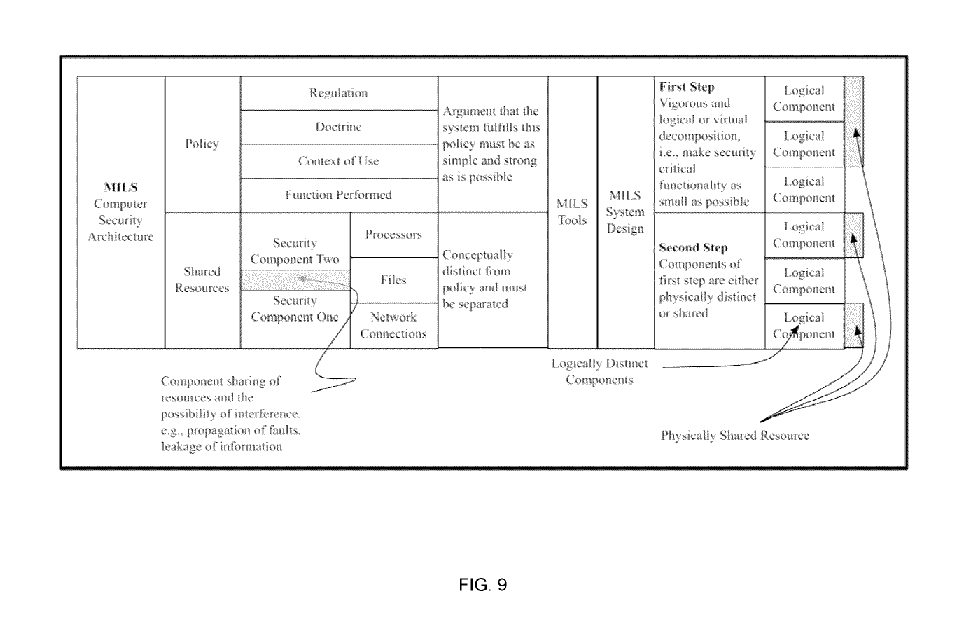

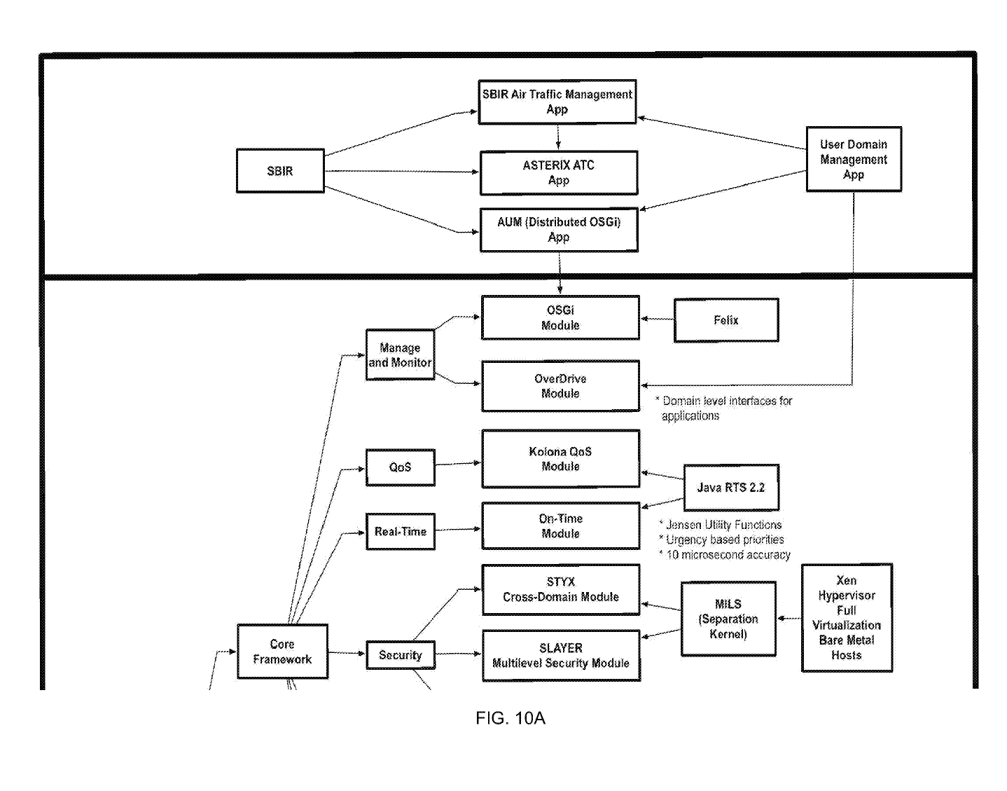

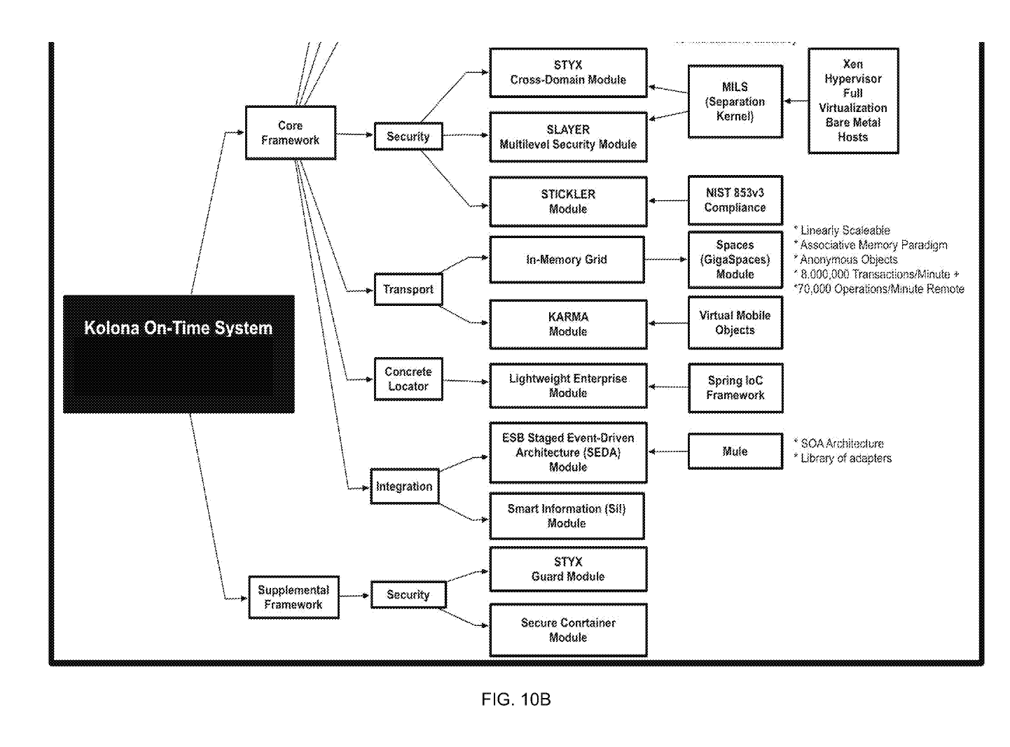

The foundation for GigaSpaces XAP and, hence, the On-Time System is the Space, a best of breed in-memory data grid. The Space is a scalable, high performance, reliable data grid implementation. Referring to FIG. 8, the primary API of the Space follows the JavaSpaces specification and the powerful tuple space model. The Space, however, contains richer functionality, supporting paradigms like POJO-based data objects, Java 5 generics and dependency injection, as expected from any modern data grid implementation.

The Space supports multiple clustering topologies (partitioned, replicated, master/local, and more) and allows you to store hundreds of gigabytes of data to be stored in the memory of your data grid instances while maintaining high availability though replication to peer instances in the cluster.

The Space can be used in a variety of ways:

1. As a clustered in-memory data repository. You can do so from Java, .Net or C++ programs and transparently share data between the languages.

2. A clustered, ultra-fast, in-memory message bus. The Space allows you to register for data updates that occur in it, for example when a new object of a certain type is written to it, or an existing object that matches a certain query or criteria is updated. The change is propagated to your even listeners as it happens, either in a point-to-point or publish-subscribe model

3. A distributed platform for running application code. The Space supports cluster wide execution of code. This allows easy conversion of the Space into a highly scalable processing grid. As part of the cluster processing you can access the local data stored on a machine that the code is running, running at in-memory speeds. If the code is executed on more than one machine, you can use the Spaces built-in support of the map/reduce design pattern and leverage the power of the entire gird using the well-known paradigm.

Using the GigaSpaces XAP transport, and partnering with GigaSpaces gives the On-Time System the following qualities or value propositions:

1. A Single Platform

2. High Performance

3. Scalability on Demand

4. Always On

5. Open

XAP simplifies the platform. XAP virtualizes middleware and data, messaging and distributed code execution in one middleware component. XAP provides high performance. XAP runs on top of the in-memory grid, which is faster and more scalable. Also, the data eventually ends up in a database, which allows external access. Using XAP's facility for data partitioning, data is nearly linearly scalable on demand across hundreds of machines. XAP is always on, being based on the Space and using replication.

3.3. Security

Recent developments in security architecture, server-grade commodity computing hardware, and bare-metal hypervisors have provided the building blocks optionally advantageous to create secure systems with the security properties that recently required large and expensive custom tools and deployment environments. The following section discusses some of the constituent parts of the Kolona On-Time System security architecture.

3.3.1. MILS

The Kolona On-Time System utilizes a Multiple Independent Layers of Security (MILS) approach to secure system design. In a MILS system, a security domain is simplified through decomposition into the most fundamental atomic security policies. Each policy is an accredit-able and independent module within the system, and these independent modules are composable into accredit-able large-scale systems. An optionally advantageous MILS element is the technology to enable virtual components and their associated communication channels to share a set of physical resources. Secure resource sharing is enabled by a MILS separation kernel, with properties commonly described as NEAT:

1. Non-bypassable: A component may not use another communication path, including lower level mechanisms to bypass the security monitor.

2. Evaluatable: Any trusted component can be evaluated to the level of assurance required of that component. This means the components are modular, well designed, well specified, well implemented, small, low complexity, etc.

3. Always invoked: Each access or message is checked by the appropriate security monitors.

4. Tamperproof: The system controls modify rights to the security monitor code, configuration and data; preventing unauthorized changes.

For the Kolona On-Time System, the MILS architecture provides the decoupling of policy concerns from resource sharing concerns.

FIG. 9 illustrates the constituent pieces of the MILS architecture, as used by the On-Time System. The figure is logically split horizontally, with security policy decomposition concerns on the top half, and resource separation concerns on the bottom. Moving from left to right, architectural components and concerns for each section are iterated. Of special note is the MILS Tools component, which describes the entities that provide the conceptual “glue” that connects policy separation and shared resources.

An example MILS Tools is a Partitioning Communication Systems (PCS), which is a component responsible for regulating communication between MILS policy nodes. On top of the MILS Tools foundation is the MILS system design with the associated two step isolation and separation. Each security concern of the Kolona On-Time System can ultimately reside in an independent, isolated, and accredited component, such as the “Logical Components” listed on the far right of the figure.

The Kolona On-Time System may adhere to principles of the MILS system by performing the aforementioned security policy decomposition to create logical components, and by reliance on the isolation features of recent Xen hypervisor releases and virtual-machine specific hardware capabilities. Individual security concerns, such as a data space containing SABI information objects, can be functionally minimized and logically isolated to a security accredited operating system container. Other isolated components contain the minimum functionality for a Cross Domain Solution (CDS), and data spaces containing information objects classified higher than SABI. Each of these isolated logical components is run as Xen Hardware Virtual Machines (HVM's), and naive to the actual hypervisor environment that is hosting them.

Independent efforts to reduce the trusted computing base of Xen, through disaggregation of the control domain, and simplification of the hypervisor core, are under development and beyond the scope of this paper.

3.3.2. Xen

The capabilities provided by the original x86 chip design have proven difficult for expressing the needs of secure and efficient hypervisors. Recently, commodity chip manufactures Intel and AMD have addressed these challenges by designing new lines of CPU's with enhanced, virtualization-specific processor extensions. The result is that standard OS such as Solaris and Windows may run unmodified as a “naive” instance managed by a capable hypervisor.

The resulting client execution speed is improved due to a larger fraction of client OS instructions running directly on hardware without the constant need for asynchronous intervention by the hypervisor. Optionally advantageously, the capability to run an operating system that is naive to the presence of its resource sharing hypervisor provides the initial step towards a goal of security through isolation, and ultimately the potential to emulate a distributed system on a single set of hardware.

At the forefront of virtualization technology is the freely available Xen hypervisor, which has received tremendous attention from security and hypervisor researchers, and boasts a significant industry following. Among Xen's strengths is an astonishing simplicity and conciseness of code-base. While Security through Correctness was not an explicitly stated Xen requirement, we assert that the design of the Xen hypervisor lends a strong possibility for high-assurance SMP and real-time computing.

### SUMMARY

We have attempted to outline elements of the architecture of the Kolona On-Time System, a TCP/IP based system capable of meeting NextGen requirements and more. Adding features to the standard containers has proved to be optionally advantageous, including real-time, an in-memory grid, the use of a distributed associative memory paradigm, and a multiple independent levels of security with a related enterprise-level hypervisor.

Appendix A: SBIR Requirements

Program: SBIR

Topic Num: AF081-028 (Air Force)

Title: Information sharing between the Global Information Grid (GIG) and the System Wide Information Management (SWIM) system.

Research & Technical Areas: Information Systems.

Objective: Protype the exchange of a radar target report exchange between the GIG and FAA System Wide Information Management (SWIM) network from the radar detection to display at the FAA in less than 2.3 second.

Description: Develop a real-time net-centric concept for sharing radar data in a multi-level security environment between the Global Information Grid (GIG) and the Federal Aviation Administration (FAA) System Wide Information Management System (SWIM). Accurate, reliable, and timely radar and Airborne Dependent Surveillance—Broadcast (ADS_B) position data with very high integrity is critical to ensure aircraft collisions are prevented. Timeliness and accuracy will be even more optionally advantageous to maintaining safety in the FAA NextGen Air Transportation System being put in place. The NextGen is being designed to handle three times the volume of air traffic as today. Many more aircraft will be squeezed into the same airspace as today. This means that blunder detection and resolution loop times will be greatly reduced. Exchange of aircraft position data must be reliable, timely and accurate with very high integrity to ensure safety. This SBIR will strive to propose a way to guarantee that the position information can enter the GIG and be received by SWIM and processed for display with high confidence in less than 2.3 seconds from detection to display. The quality of Service of both networks can be defined to ensure that position data (radar and ADS-B) reliably reaches its destination with high integrity. Background: Information can be exchanged between aircraft, ground radars and ground ATM facilities to ensure safe and efficient operation of the aviation system. These same aircraft, radars and ATM facilities can be sending and receiving position and flight change information between the GIG to the SWIM network using internet protocol technology (IPV6). The GIG can be used to share real-time position information (including radar and ADS-B position data), issue and acknowledge controller instructions, update flight plans, provide threat information, etc. Critical flight information can pass both ways to ensure safety of flight and to allow military aircraft to fly through civil airspace to accomplish their missions. It is envisioned that control instructions and other information can be transmitted from the FAA ATM facility over SWIM to an appropriate gateway with the GIG then to the aircraft via data link and vice versa. The airborne transmission path can be direct to a SWIM gateway or via data link between the aircraft and military ground station directly or by using military satellites, thence from the GIG to the SWIM. Both GIG and SWIM are IP based and use XML, however they may not be used for flight critical information until the appropriate quality of service for the information to be transferred is assured. This exchange is optionally advantageous to enable information to be shared across civil and military enterprises in the interest of air transportation safety and the expeditious coordinated movement of air traffic worldwide. The data to be exchanged varies from near real-time radar data in ASTERIX over IP with strict latency requirements, (0.3 sec for transmission and a total of 2.3 seconds from detection to display) to flight plan information that can tolerate much longer latencies. A priority system and a Quality of Service (QoS) scheme can be developed to insure that time critical information such as radar, ADS-B and control instructions are received without delay. The exchange of data using the GIG and SWIM has the potential to minimize the unique avionics optionally advantageous on board military aircraft to achieve access to civil airspace worldwide.

PHASE I: Develop a priority scheme and Quality of Service plan that can ensure the exchange of radar, ADS-B and air traffic control data between the GIG and SWIM on networks that also carry data with varying levels of criticality. Deliver plan with success criteria for building prototype software/hardware.

PHASE II: Build the prototype described in Phase I and demonstrate that the prototype provides real-time transfer of position information and air traffic control instructions using the criteria developed in Phase I. Insure quality of service considerations are addressed.

PHASE III: DUAL USE: Military application: Allow DoD to provide information over GIG to civilian ATC using existing avionics. Allows civil agencies to track & control aircraft in civil airspace using information over the GIG/SWIM interface. Commercial application: The resulting interface can be used by civil aviation authorities worldwide to provide service to US military aircraft without having to equip their facilities with special equipment unique to handle

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A system, comprising elements described above herein.

2. A method, comprising steps described above herein.
